(19) United States
(12) Patent Application Publication
(10) Pub. No.: US 2026/0143180 A1
(43) Pub. Date: May 21, 2026

(54) INFORMATION PROVISION APPARATUS, INFORMATION PROVISION SYSTEM, AND INFORMATION PROVISION METHOD

(71) Applicants: Ayane SAITO, Kanagawa (JP); Erika OKAWA, Tokyo (JP)

(72) Inventors: Ayane SAITO, Kanagawa (JP); Erika OKAWA, Tokyo (JP)

(21) Appl. No.: 19/386,265

(22) Filed: Nov. 12, 2025

(30) Foreign Application Priority Data
Nov. 18, 2024 (JP) 2024-200370

(51) Int. Cl. H04N 21/2343; G06F 16/955; H04N 21/239; H04N 21/262; H04N 21/485

(52) U.S. Cl. CPC H04N 21/234363; G06F 16/9566; H04N 21/2396; H04N 21/26258; H04N 21/4854

(57) ABSTRACT

An information provision apparatus includes circuitry. The circuitry creates a playlist including first content to be displayed on a display apparatus. In response to receiving a request for issuing access information for providing the first content to an information terminal used by a user, the circuitry issues the access information. The circuitry distributes the first content included in the playlist. In response to receiving access from the information terminal using the access information, the circuitry provides the information terminal with second content optimized for the information terminal, the second content being created from the first content and to be displayed on the information terminal.

### CROSS-REFERENCE TO RELATED APPLICATION

This patent application is based on and claims priority pursuant to 35 U.S.C. § 119(a) to Japanese Patent Application No. 2024-200370, filed on Nov. 18, 2024, in the Japan Patent Office, the entire disclosure of which is hereby incorporated by reference herein.

### BACKGROUND

### Technical Field

Embodiments of the present disclosure relate to an information provision apparatus, an information provision system, and an information provision method.

### Related Art

There is an information provision system that provides content such as moving-image content or still-image content to a plurality of display apparatuses such as digital signage.

A technique is known that distributes content to client apparatuses in game distribution.

### SUMMARY

The present disclosure described herein provides an information provision apparatus including circuitry. The circuitry creates a playlist including first content to be displayed on a display apparatus. In response to receiving a request for issuing access information for providing the first content to an information terminal used by a user, the circuitry issues the access information. The circuitry distributes the first content included in the playlist. In response to receiving access from the information terminal using the access information, the circuitry provides the information terminal with second content optimized for the information terminal, the second content being created from the first content and to be displayed on the information terminal.

The present disclosure described herein provides an information provision system. The information provision system includes an information provision apparatus including first circuitry and an administrator terminal including second circuitry and being communicable with the information provision apparatus. The first circuitry creates a playlist including first content to be displayed on a display apparatus. In response to receiving a request for issuing access information for providing the first content to an information terminal used by a user, the first circuitry issues the access information. The first circuitry distributes the first content included in the playlist. In response to receiving access from the information terminal using the access information, the first circuitry provides the information terminal with second content optimized for the information terminal, the second content being created from the first content and to be displayed on the information terminal. The second circuitry displays a setting screen for receiving an input of first link information for displaying information relating to the first content. In response to receiving the input of the first link information, the second circuitry transmits the first link information to the information provision apparatus.

The present disclosure described herein provides an information provision method including creating a playlist including first content to be displayed on a display apparatus, in response to receiving a request for issuing access information for providing the first content to an information terminal used by a user, issuing the access information, distributing the first content included in the playlist, and in response to receiving access from the information terminal using the access information, providing the information terminal with second content optimized for the information terminal, the second content being created from the first content and to be displayed on the information terminal.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example system configuration of an information provision system;

FIG. 2 is a diagram illustrating an example hardware configuration of a computer;

FIG. 3 is a diagram illustrating an example hardware configuration of an information terminal;

FIG. 4 is a diagram illustrating an example functional configuration of the information provision system;

FIGS. 5A and 5B (FIG. 5) are tables illustrating example playlist information;

FIG. 6 is a first view of an example setting screen according to a first embodiment;

FIG. 7 is a second view of the example setting screen according to the first embodiment;

FIG. 8 is a first sequence diagram illustrating an example setting process according to the first embodiment;

FIG. 9 is a third view of the example setting screen according to the first embodiment;

FIG. 10 is a fourth view of the example setting screen according to the first embodiment;

FIG. 11 is a second sequence diagram illustrating the example setting process according to the first embodiment;

FIG. 12 is a fifth view of the example setting screen according to the first embodiment;

FIG. 13 is a flowchart illustrating an example provision process according to the first embodiment;

FIG. 14 is a first view of an example display screen without a reproduction list;

FIG. 15 is a second view of the example display screen without a reproduction list;

FIG. 16 is a view of an example display screen with a reproduction list;

FIG. 17 is a sequence diagram illustrating an example access restriction setting process according to a second embodiment;

FIG. 18 is a view of an example access-restriction setting screen according to the second embodiment; and

FIG. 19 is a flowchart illustrating an example process performed in accordance with the data transfer volume according to a third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### System Configuration

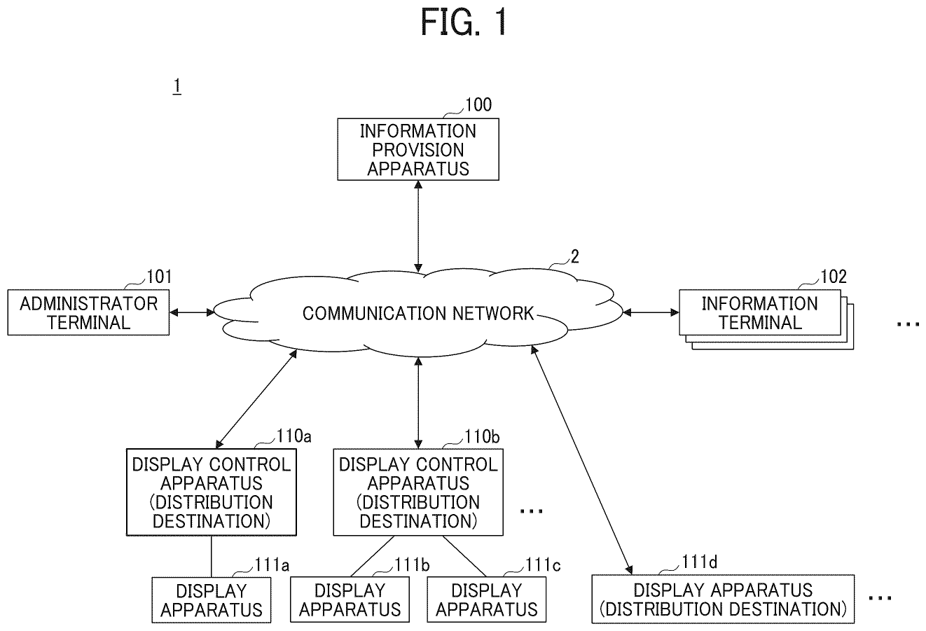

FIG. 1 is a diagram illustrating an example system configuration of an information provision system 1. The information provision system 1 includes, for example, an information provision apparatus 100, an administrator terminal 101, one or more information terminals 102, a plurality of display control apparatuses 110, and a plurality of display apparatuses 111. Hereinafter, a “display control apparatus 110” refers to any one or all of the display control apparatuses 110 such as display control apparatuses 110a and 110b illustrated in FIG. 1. Similarly, a “display apparatus 111” refers to any one or all of the display apparatuses 111 such as display apparatuses 111a, 111b, 111c, and 111d illustrated in FIG. 1.

The display control apparatus (distribution destination) 110 is communicably connected to the information provision apparatus 100 via a communication network 2, which includes, for example, the Internet and a local area network (LAN). The display control apparatus 110 is implemented by a computer and executes a predetermined program to perform a display control process to cause the display apparatus 111 to display first content distributed from the information provision apparatus 100. The first content includes, for example, at least one of moving-image content and still-image content.

The display control apparatus 110 is, for example, a set-top box (STB) that causes the display apparatus 111 connected to the display control apparatus 110 to display the first content distributed from the information provision apparatus 100. The display control apparatus 110 may also be an STB that causes two or more display apparatuses 111 connected to the display control apparatus 110 to display the first content distributed from the information provision apparatus 100. In the example illustrated in FIG. 1, the display control apparatus 110b is connected to the display apparatuses 111b and 111c.

The display apparatus 111 is, for example, digital signage but is not limited thereto. The display apparatus 111 may be any of various display apparatuses such as a display, a monitor, and a projector. Part or all of the display apparatuses 111 may have a function of the display control apparatus 110 and display the first content distributed from the information provision apparatus 100, independently of the display control apparatus 110. In the example illustrated in FIG. 1, the display apparatus 111d (distribution destination) is not connected to any display control apparatus 110 and has the function of the display control apparatus 110.

The display control apparatus 110 and the display apparatus 111 are disposed in a predetermined location such as a lobby, a corridor, an elevator, or an office to provide various types of information. Specifically, the display apparatus 111 displays the first content distributed from the information provision apparatus 100 or the display control apparatus 110 causes the display apparatus 111 connected to the display apparatus 111 to display the first content.

The information provision apparatus 100 is an information processing apparatus including one or more computers. The information provision apparatus 100 distributes the first content including one or more content data to the display apparatus 111, which is disposed in a predetermined location, or the display control apparatus 110, which is disposed in a predetermined location and causes the display apparatus 111 to display the first content.

The information provision apparatus 100 according to the present embodiment creates second content based on the first content and provides the created second content to the information terminal 102 used by a user to cause the information terminal 102 to display the second content. In one usage example, the information terminal 102 used by the user may be the information terminal 102 provided by a company. In another usage example, the information terminal 102 used by the user may be the information terminal 102 owned or possessed by the user.

The administrator terminal 101 is an information processing apparatus used by, for example, an administrator who manages the information provision system 1. Examples of the administrator terminal 101 include a personal computer (PC), a tablet terminal, and a smartphone. The administrator terminal 101 is, for example, used by the administrator to perform various settings on the information provision apparatus 100.

The information terminal 102 is an information processing apparatus used by a user who uses the information provision system 1. Examples of the information terminal 102 include a PC, a tablet terminal, and a smartphone. The information terminal 102 is, for example, used by the user to view the second content provided by the information provision apparatus 100.

In one example use case, the information provision apparatus 100 distributes the first content to the display control apparatus 110 or the display apparatus 111 disposed in a predetermined location within a company to cause the display apparatus 111 to display information included in the first content. The information provision apparatus 100 also provides the second content, which includes the same information as the first content, to the information terminal 102 used by the user who is the employee of the company. This allows the user to display the same information as the first content on the information terminal 102 at any user's work location (e.g., inside or outside the office, at home, or in a satellite office).

In the above-described use case, there is a demand to distribute content displayed on a display apparatus such as digital signage disposed in a predetermined location to an information terminal used by a user. However, it has not been considered to display the content on the information terminal used by the user in addition to the display apparatus such as digital signage disposed in the predetermined location. The information provision system 1 according to the present embodiment allows the content to be displayed on the information terminal 102 used by the user in addition to the display apparatus 111 disposed in the predetermined location. In the above-described use case, the first content has a large file size with high resolution such as 4,000(4 K) resolution to correspond to the display size of the display apparatus 111 disposed in a company. However, when the first content is displayed on the display apparatus 111 disposed in the company, the number of times the first content is downloaded to the display control apparatus 110 or the display apparatus 111 is just one. Therefore, the network load and data transfer volume do not become significant issues.

Meanwhile, in a case where the information terminals 102 used by users who are the employees of the company are provided with the first content with its original size, the network load and the data transfer volume in the company increase. This is because the number of information terminals 102 tends to be greater than the number of display control apparatuses 110 or display apparatuses 111. In particular, in a case where the file size of the first content has exceeded the cache size of a browser, the first content is downloaded each time the first content is displayed. This problematically increases the network load and the data transfer volume even further.

There is also a demand to add link information to the content to be displayed on the information terminal 102 used by the user. This link information navigates the user to information relating to the first content. However, the first content displayed on the display apparatus 111 does not include the link information. This causes the administrator to create another content to be displayed on the information terminal 102 with the link information added. Therefore, the workload of the administrator increases.

Therefore, the information provision system 1 according to the present embodiment easily creates the second content, to which the link information is added and which is to be distributed to the information terminal 102, from the first content to be displayed on the display apparatus 111 disposed in a predetermined location.

### Example Hardware Configuration

### Example Hardware Configuration of Information Provision Apparatus and Administrator Terminal

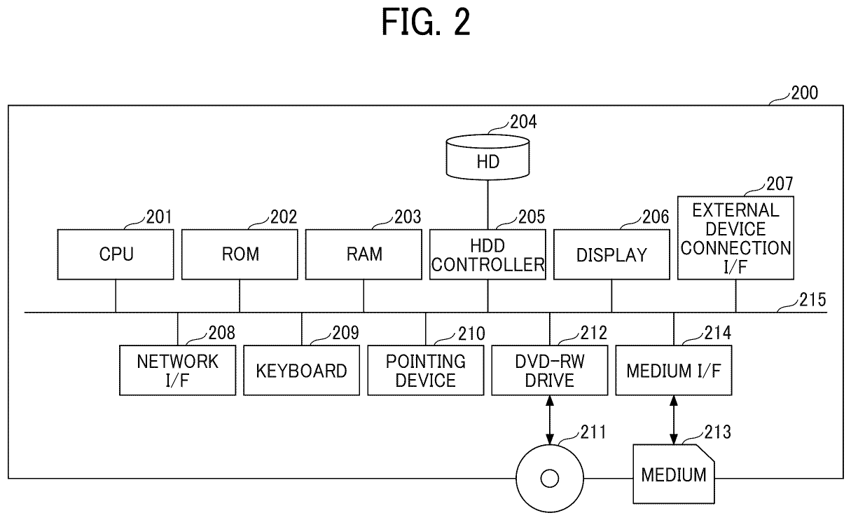

For example, the information provision apparatus 100 and the administrator terminal 101 have a hardware configuration of a computer 200 as illustrated in FIG. 2. The information provision apparatus 100 may include, for example, a plurality of computers 200 or a virtual machine on a cloud. The administrator terminal 101 may have the hardware configuration of the information terminal 102 described later.

FIG. 2 is a diagram illustrating the example hardware configuration of the computer 200. As illustrated in FIG. 2, the computer 200 includes, for example, a central processing unit (CPU) 201, a read-only memory (ROM) 202, a random-access memory (RAM) 203, a hard disk (HD) 204, a hard disk drive (HDD) controller 205, a display 206, an external device connection interface (I/F) 207, a network I/F 208, a keyboard 209, a pointing device 210, a digital versatile disk-rewritable (DVD-RW) drive 212, a medium I/F 214, and a bus line 215.

The CPU 201 controls the operation of the computer 200. The ROM 202 stores, for example, programs such as an initial program loader (IPL) for executing the computer 200. The RAM 203 is, for example, used as a work area for the CPU 201. The HD 204 stores various data and programs such as an operating system (OS), an application, and a device driver. The HDD controller 205 controls, for example, the reading and writing of various data from and to the HD 204 under the control of the CPU 201.

The display 206 displays various pieces of information such as a cursor, menus, windows, characters, and images. The display 206 may be disposed outside the computer 200. The external device connection I/F 207 is an interface such as a universal serial bus (USB) for connecting various external devices such as local devices to the computer 200. The network I/F 208 is an interface for data communication via the communication network 2.

The keyboard 209 is an example of an input device including a plurality of keys for inputting, for example, characters, numerical values, and various instructions. The pointing device 210 is an example of an input device that allows the user to select or execute various instructions, select a target to be processed, and move a cursor being displayed. The keyboard 209 and the pointing device 210 may be disposed outside the computer 200.

The DVD-RW drive 212 controls the reading and writing of various data from and to a DVD-RW 211, which is an example of a removable recording medium. The DVD-RW 211 is not limited to a DVD-RW and may be another removable recording medium. The medium I/F 214 controls the reading and writing (storing) of data from and to a recording medium 213 such as a flash memory. The bus line 215 includes an address bus, a data bus, and various control signals for electrically connecting the above-described components to each other.

The configuration of the computer 200 illustrated in FIG. 2 is merely an example. As long as the computer 200 includes, for example, the CPU 201, the ROM 202, the RAM 203, the network I/F 208, and the bus line 215, the computer 200 may have any configuration.

### Hardware Configuration of Information Terminal

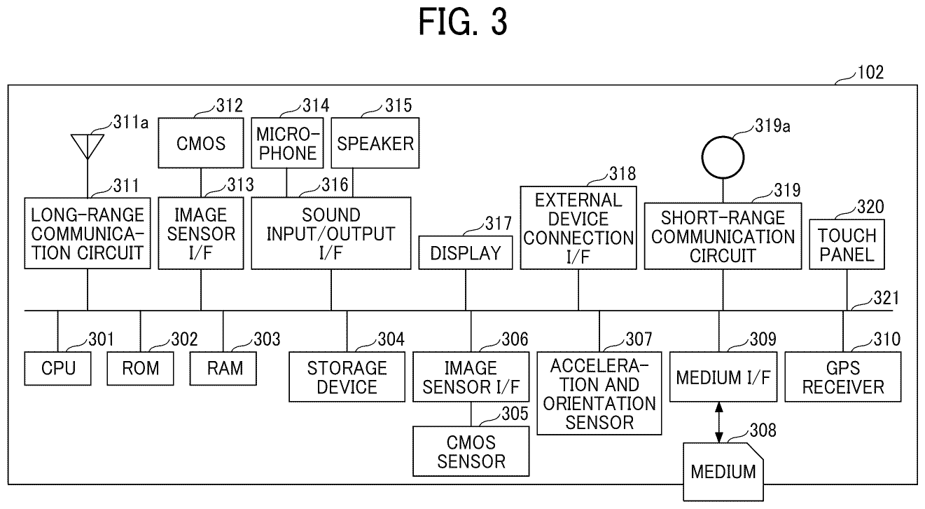

The information terminal 102 has, for example, a hardware configuration as illustrated in FIG. 3. Alternatively, the information terminal 102 may have, for example, the hardware configuration of the computer 200 described with reference to FIG. 2.

FIG. 3 is a diagram illustrating an example hardware configuration of the information terminal 102. As illustrated in FIG. 3, the information terminal 102 includes, for example, a CPU 301, a ROM 302, a RAM 303, a storage device 304, a complementary metal-oxide semiconductor (CMOS) sensor 305, an image sensor I/F 306, an acceleration and orientation sensor 307, a medium I/F 309, and a global positioning system (GPS) receiver 310.

The CPU 301 executes a predetermined program to control the operation of the information terminal 102. The ROM 302 stores, for example, programs such as an initial program loader (IPL) for executing the CPU 301. The RAM 303 is, for example, used as a work area for the CPU 301. The storage device 304 is a large-capacity storage device that stores various data and programs such as an operating system (OS) and an application.

The CMOS sensor 305 is an example of a built-in imaging device that captures an image of a subject (mainly a self-portrait image) and obtains image data under the control of the CPU 301. The information terminal 102 may include another imaging device such as a charge-coupled device (CCD) sensor, instead of the CMOS sensor 305. The image sensor I/F 306 is a circuit that controls the driving of the CMOS sensor 305. The acceleration and orientation sensor 307 includes various sensors such as an electromagnetic compass that detects geomagnetism, a gyrocompass, and an acceleration sensor. The medium I/F 309 controls the reading and writing (storing) of data from and to a medium (recording medium) 308 such as a flash memory. The GPS receiver 310 is a positioning device that receives a GPS signal (positioning signal) from a GPS satellite.

The information terminal 102 also includes, for example, a long-range communication circuit 311, an antenna 311a of the long-range communication circuit 311, a CMOS sensor 312, an image sensor I/F 313, a microphone 314, a speaker 315, a sound input/output I/F 316, a display 317, an external device connection I/F 318, a short-range communication circuit 319, an antenna 319a of the short-range communication circuit 319, and a touch panel 320.

The long-range communication circuit 311 is, for example, a circuit that communicates with other apparatuses through the communication network 2. The CMOS sensor 312 is an example of a built-in imaging device that captures an image of a subject and obtains image data under the control of the CPU 301. The image sensor I/F 313 is a circuit that controls the driving of the CMOS sensor 312. The microphone 314 is a built-in circuit that converts sound into an electrical signal. The speaker 315 is a built-in circuit that converts an electrical signal into physical vibration to generate sound such as music or voice. The sound input/output I/F 316 is a circuit that controls the input and output of a sound-wave signal between the microphone 314 and the speaker 315 under the control of the CPU 301.

The display 317 is an example of a display device such as a liquid-crystal display device or an organic electro-luminescence (EL) display device that displays, for example, an image of a subject and various icons. The external device connection I/F 318 is an interface for connecting various external devices to the information terminal 102. The short-range communication circuit 319 includes a circuit that performs short-range wireless communication. The touch panel 320 is an example of an input device that allows the user to operate the information terminal 102 by touching the display 317.

The information terminal 102 includes a bus line 321. The bus line 321 includes, for example, an address bus, a data bus, and various control signals for electrically connecting the above-described components such as the CPU 301 illustrated in FIG. 3 to each other.

### Hardware Configuration of Display Control Apparatus and Display Apparatus

The display control apparatus 110 and the display apparatus 111 have a hardware configuration of a computer including, for example, a CPU, a ROM, a RAM, and a network I/F. As long as the display control apparatus 110 and the display apparatus 111 have the hardware configuration of the computer, the display control apparatus 110 and the display apparatus 111 may have any configuration as hardware.

### Functional Configuration

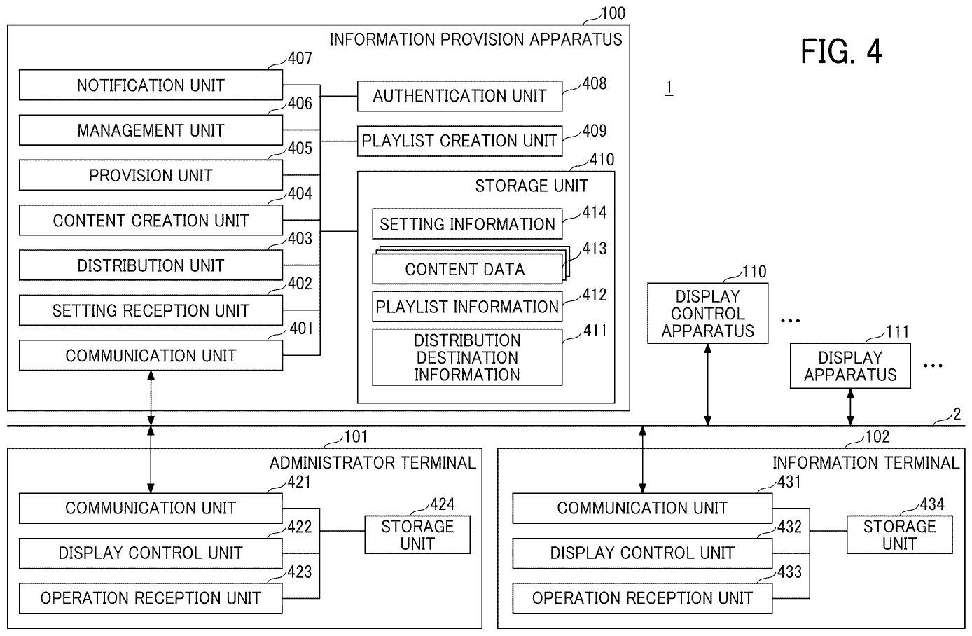

FIG. 4 is a diagram illustrating an example functional configuration of the information provision system 1.

### Functional Configuration of Information Provision Apparatus

The information provision apparatus 100 executes a predetermined program on one or more computers 200 included in the information provision apparatus 100 to implement, for example, functional units as illustrated in FIG. 4. In the example illustrated in FIG. 4, the information provision apparatus 100 includes, for example, a communication unit 401, a setting reception unit 402, a distribution unit 403, a content creation unit 404, a provision unit 405, a management unit 406, a notification unit 407, an authentication unit 408, a playlist creation unit 409, and a storage unit 410. At least part of the above-described functional units may be implemented by hardware.

The communication unit 401 performs a communication process to connect the information provision apparatus 100 to the communication network 2 using, for example, the network I/F 208, and communicate with, for example, the display control apparatus 110, the administrator terminal 101, and the information terminal 102.

The setting reception unit 402 performs a setting reception process to receive various types of setting information 414 relating to the information provision system 1. For example, the setting reception unit 402 causes the administrator terminal 101 to display a web page displaying various setting screens, and receives setting information set on the setting screens. Alternatively, the setting reception unit 402 may provide, for example, an application programming interface (API) to an administrator program for the information provision system 1 that runs on the administrator terminal 101 where the API is used to set various types of setting information.

The setting reception unit 402 according to the present embodiment receives, for example, an input of first link information for displaying information relating to the first content. When the setting reception unit 402 receives a request for issuing access information for providing the first content included in a playlist to the information terminal 102, the setting reception unit 402 issues the access information. Preferably, the setting reception unit 402 receives a setting for content data included in the first content. Preferably, the setting reception unit 402 receives a setting of access restriction to the second content. The access information refers to, for example, information indicating a location that is accessed by the information terminal 102 to display content.

The first content refers to content that is distributed from the information provision apparatus 100 to the display apparatus 111, which is disposed in a predetermined location, or the display control apparatus 110, which is disposed in a predetermined location and causes the display apparatus 111 to display the content. The first content includes at least one of one or more items of moving-image content and one or more items of still-image content. The moving-image content and the still-image content may or may not include sound or sound data.

The second content, which is provided from the information provision apparatus 100 to the information terminal 102 used by the user, refers to content created from the first content and having a data size smaller than the first content. The second content may include the first link information, which is link information such as a uniform resource locator (URL) for displaying information relating to the first content.

The distribution unit 403 performs a distribution process to distribute the first content included in the playlist to the display apparatus 111, which is disposed in a predetermined location, or the display control apparatus 110, which is disposed in a predetermined location and causes the display apparatus 111 to display the first content. In the present embodiment, the distribution unit 403 may distribute the first content in any way. For example, the distribution unit 403 may distribute the first content before the first content is displayed at a specified time. In another example, the distribution unit 403 may distribute the first content at a timing when the first content is displayed.

The content creation unit 404 performs a creation process to create the second content optimized for the information terminal 102 from the first content. For example, when the setting reception unit 402 receives an input of the first link information, the content creation unit 404 creates the second content that has a data size smaller than the first content and that displays the first link information. When the setting reception unit 402 has not received the input of the first link information, the content creation unit 404 creates the second content that has a data size smaller than the first content. In the present embodiment, the term “optimization” refers to optimizing the content such that the condition of the content being created best suits given constraints such as the performance of the information terminal 102 and the network load of the communication network 2.

The content creation unit 404 reduces the data size of the first content by, for example, reducing the resolution of an image included in the first content (moving-image content or still-image content) or compressing the image included in the first content. Reducing the data size of the first content, reducing the resolution of the image included in the first content, and compressing the image included in the first content are examples of the process of creating the second content optimized for the information terminal 102.

In another example, in a case where the display control apparatus 110 is disposed in a location where a communication line is narrower than a communication line of the information terminal 102, the content creation unit 404 may increase the resolution of an image included in the first content to create the second content optimized for the information terminal 102. For example, the content creation unit 404 may increase the resolution by converting a full high-definition (HD) image to a 4K image.

As described above, the first link information includes, for example, a URL for displaying information relating to the first content, which is distributed to the display apparatus 111 or the display control apparatus 110. For example, in a case where the first content is image data with 4K resolution and the second content is image data with HD resolution having a lower resolution than 4K resolution, the first link information may include URL information for displaying image data with 4K resolution having the same content as the first content. In another example, in a case where the first content is image data for announcing the release of a new product, the first link information may include URL information for displaying the details of the new product.

The provision unit 405 performs a provision process to provide the second content created by the content creation unit 404 to the information terminal 102 used by the user. For example, when the provision unit 405 receives access from the information terminal 102 using link information such as a URL for displaying the second content (hereinafter referred to as second link information), the provision unit 405 provides the second content created by the content creation unit 404 to the information terminal 102. The second link information is an example of access information.

The management unit 406 performs a management process to manage the data transfer volume of at least one of the first content and the second content. For example, the management unit 406 manages the number of downloads of the second content and calculates a monthly data transfer volume based on the data size of the second content. The management unit 406 may, for example, manage the number of distributions of the first content and the number of downloads of the second content, and calculate a monthly data transfer volume based on the data size of the first content and the data size of the second content.

The management unit 406 may also manage, for example, the data transfer volume measured in real time or the data transfer volume measured at predetermined intervals (e.g., every day or every hour).

In a case where the data transfer volume managed by the management unit 406 has exceeded a predetermined threshold value (hereinafter referred to as a second threshold value), the notification unit 407 performs a notification process to notify a predetermined notification destination (e.g., an email address of the administrator) that the data transfer volume has exceeded the second threshold value.

The authentication unit 408 performs an authentication process to authenticate whether or not the administrator accessing the information provision apparatus 100 using the administrator terminal 101 is an administrator registered in the information provision system 1. The authentication unit 408 may authenticate the administrator using, for example, an external authentication server.

The playlist creation unit 409 performs a playlist creation process to create a playlist, which is a reproduction list including the first content. For example, the playlist creation unit 409 creates playlist information 412 described later. The playlist creation unit 409 may create a playlist including just one item of content. In this case as well, the information provision apparatus 100 allows the display and reproduction of the content included in the playlist.

The storage unit 410 is implemented by, for example, a program executed by the CPU 201, the HD 204, and the HDD controller 205. The storage unit 410 stores various types of information, data, and programs, such as distribution destination information 411, the playlist information 412, content data 413, and the setting information 414.

The distribution destination information 411 includes, for example, information for managing distribution destinations such as the display control apparatus 110 and the display apparatus 111 to which the first content is distributed. For example, the distribution destination information 411 manages the name, identification information, and internet protocol (IP) address of a distribution destination. The distribution destination information 411 is pre-set by, for example, the administrator. In the present embodiment, the distribution destination information 411 may have any format.

The playlist information 412 includes information for managing the first content that is distributed by the distribution unit 403.

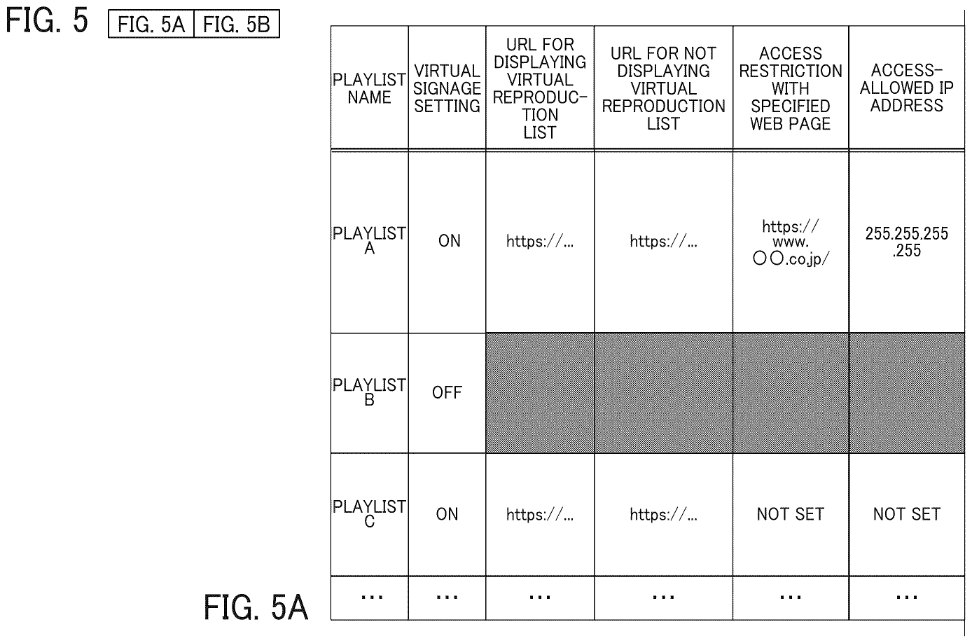

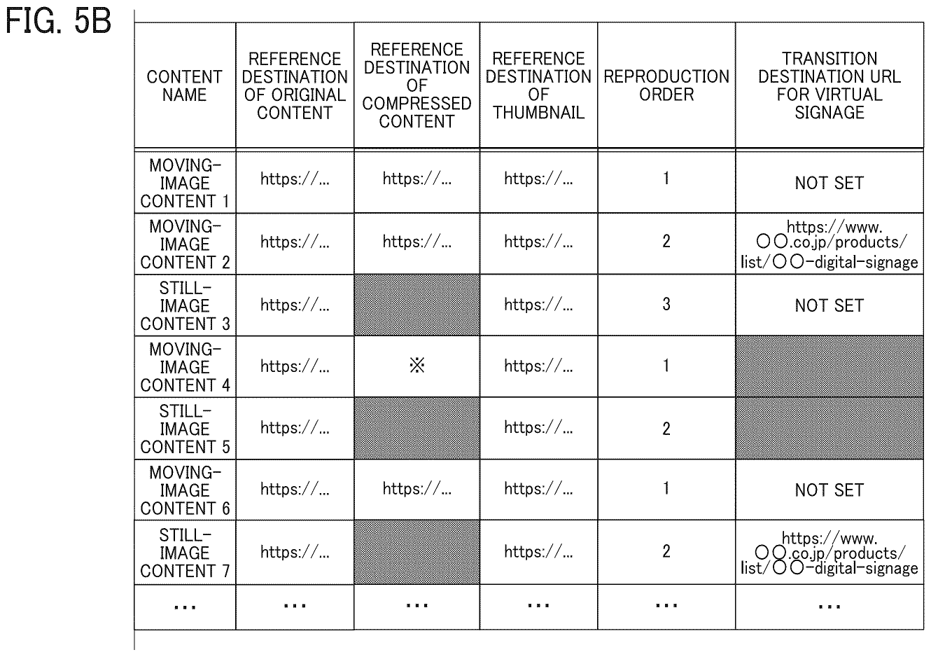

FIGS. 5A and 5B (FIG. 5) are tables illustrating example playlist information. In the example illustrated in FIG. 5, the playlist information 412 includes items of information such as “playlist name,” “virtual signage setting,” “URL for displaying a virtual reproduction list,” “URL for not displaying a virtual reproduction list,” “access restriction with a specified display page,” “access-allowed IP address,” “content name,” “reference destination of original content,” “reference destination of compressed content,” “reference destination of a thumbnail,” “reproduction order,” and “transition destination URL for virtual signage.”

The item “playlist name” includes information indicating the name of a playlist. The playlist name may be, for example, the playlist number or the playlist ID. In the example illustrated in FIG. 5, the first content distributed by the distribution unit 403 is used as an example of the playlist. The playlist may be referred to by another name such as “program.”

The item “virtual signage setting” includes information indicating whether the second content is provided (ON) or not (OFF). In the example illustrated in FIG. 5, the second content to be displayed on the information terminal 102 is an example of virtual signage. Virtual signage may also be referred to by another name such as “pseudo signage” or “personal signage.”

The item “URL for displaying a virtual reproduction list” includes the second link information (e.g., a URL) for displaying the second content with a reproduction list described later. The item “URL for not displaying a virtual reproduction list” includes the second link information for displaying the second content without a reproduction list described later.

The item “access restriction with a specified display page” includes an access-allowed URL that is permitted for access. With the access-allowed URL specified, the second content is allowed to be displayed only on the specified web page. The item “access-allowed IP address” includes an access-allowed IP address that is granted access to the second content. With the access-allowed IP address specified, the second content is allowed to be displayed only in a case where the access is made using the specified IP address.

The item “content name” includes information indicating the name of the content (moving-image content or still-image content) included in the first content. The content name may be, for example, the content number or the content ID. The item “reference destination of original content” includes information such as a URL indicating the reference destination of the content (original content) corresponding to the content name. The item “reference destination of compressed content” includes information such as a URL indicating the reference destination of the content with a reduced data size. The content with the reduced data size is obtained by, for example, reducing the resolution of the original content or compressing the original content. The item “reference destination of a thumbnail” includes information such as a URL indicating the reference destination of an image (still image) used as a thumbnail for the content corresponding to the content name. A portion marked with “*” indicates that the presence or absence of the reference destination may change depending on a timing at which a compressed moving-image file is created.

The item “reproduction order” includes information indicating the reproduction order of the content. The item “transition destination URL for virtual signage” includes the first link information (e.g., a URL), which is link information for displaying information relating to the first content and to be displayed on the second content.

Referring back to FIG. 4, the content data 413 stored in the storage unit 410 includes various items of moving-image content and still-image content that may be incorporated into the first content. The content data 413 may be acquired from the outside of the information provision apparatus 100. The setting information 414 stored in the storage unit 410 includes various types of setting information relating to the information provision system 1.

The functional units of the information provision apparatus 100 illustrated in FIG. 4 are merely examples. For example, the storage unit 410 may be implemented by a storage server or a cloud server disposed outside the information provision apparatus 100 or the information provision system 1. Additionally, the authentication unit 408 may be implemented by an authentication server disposed outside the information provision apparatus 100 or the information provision system 1 or implemented using an authentication service provided outside the information provision apparatus 100 or the information provision system 1. The functional units of the information provision apparatus 100 may be distributed across a plurality of apparatuses.

### Functional Configuration of Administrator Terminal

A functional configuration of the administrator terminal 101, which has, for example, the hardware configuration of the computer 200 as illustrated in FIG. 2, is described below.

For example, the administrator terminal 101 implements functional units by the CPU 201 executing a web browser or a program such as an application corresponding to the information provision system 1, as illustrated in FIG. 4. In the example illustrated in FIG. 4, the administrator terminal 101 includes, for example, a communication unit 421, a display control unit 422, an operation reception unit 423, and a storage unit 424.

The communication unit 421 performs a communication process to connect the administrator terminal 101 to the communication network 2 using, for example, the network I/F 208 and communicate with apparatuses such as the information provision apparatus 100.

The display control unit 422 performs a display control process to display various setting screens on a display device such as the display 206. For example, the display control unit 422 has a web browser function and acquires a web page provided by the setting reception unit 402 of the information provision apparatus 100 to display a setting screen. Alternatively, the display control unit 422 may display a setting screen created by, for example, an administrator application that runs on the administrator terminal 101.

The operation reception unit 423 performs an operation reception process to receive an operation performed on a setting screen displayed by the display control unit 422. The operation reception unit 423 transmits the received setting information to the information provision apparatus 100 via the communication unit 421.

The storage unit 424 is implemented by, for example, a program executed by the CPU 201, the HD 204, the HDD controller 205, and the RAM 203 and stores various data, information, and programs.

### Functional Configuration of Information Terminal

A functional configuration of the information terminal 102, which has, for example, the hardware configuration as illustrated in FIG. 3, is described below.

For example, the information terminal 102 implements functional units by the CPU 301 executing a web browser or a program such as an application corresponding to the information provision system 1, as illustrated in FIG. 4. In the example illustrated in FIG. 4, the information terminal 102 includes, for example, a communication unit 431, a display control unit 432, an operation reception unit 433, and a storage unit 434.

The communication unit 431 performs a communication process to connect the information terminal 102 to the communication network 2 using, for example, the long-range communication circuit 311 and communicate with apparatuses such as the information provision apparatus 100.

The display control unit 432 performs a display control process to display various setting screens on a display device such as the display 317. For example, the display control unit 432 has a web browser function and displays the second content provided by the provision unit 405 of the information provision apparatus 100.

The operation reception unit 433 performs an operation reception process to receive operations performed on various setting screens displayed by the display control unit 432. The operation reception unit 433 transmits the received operation information to, for example, the information provision apparatus 100 when necessary. The storage unit 434 is implemented by, for example, a program executed by the CPU 301, the ROM 302, the RAM 303, and the storage device 304. The storage unit 434 stores various types of data, information, and programs.

### Processing Flow

A processing flow of an information provision method according to one or more embodiments of the present disclosure is described below.

### FIRST EMBODIMENT

### Method for Creating Playlist

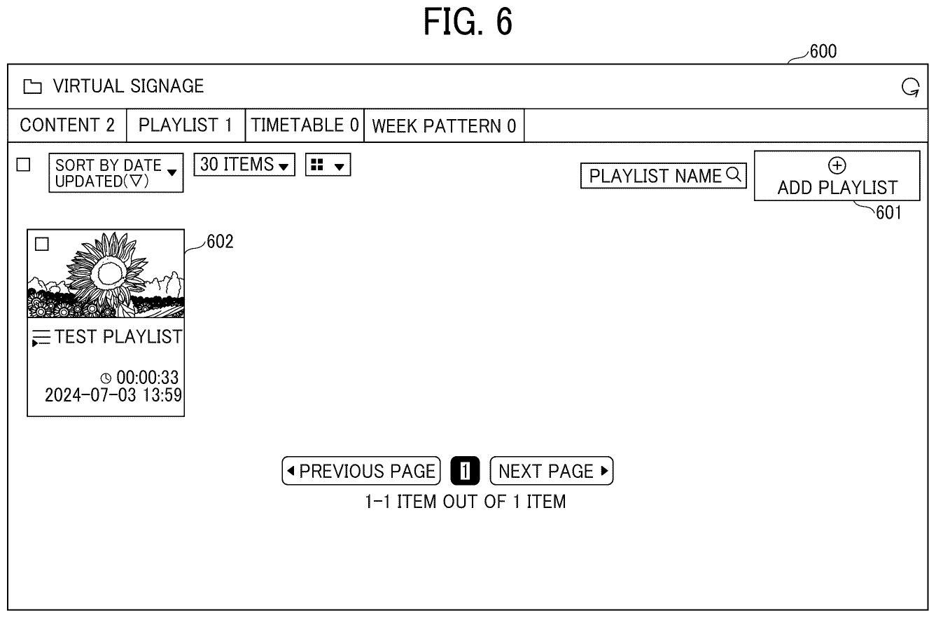

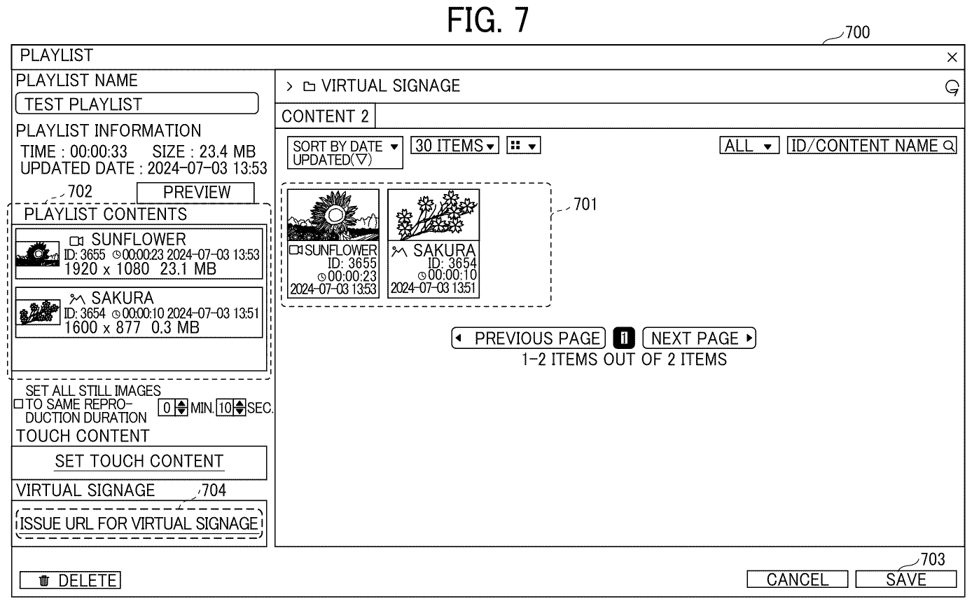

FIG. 6 is a view of an example setting screen according to a first embodiment. Specifically, FIG. 6 illustrates an example of a setting screen 600, which is displayed on the administrator terminal 101. The administrator may select an “add playlist” button 601 in the upper right of the setting screen 600 to display, for example, a playlist setting screen 700 as illustrated in FIG. 7.

In the playlist setting screen 700, the administrator may drag and drop content from a content list 701 to playlist contents 702 and select a “save” button 703 to create a playlist. In response to the user's creation operation, the playlist creation unit 409 creates the playlist.

### Setting Process

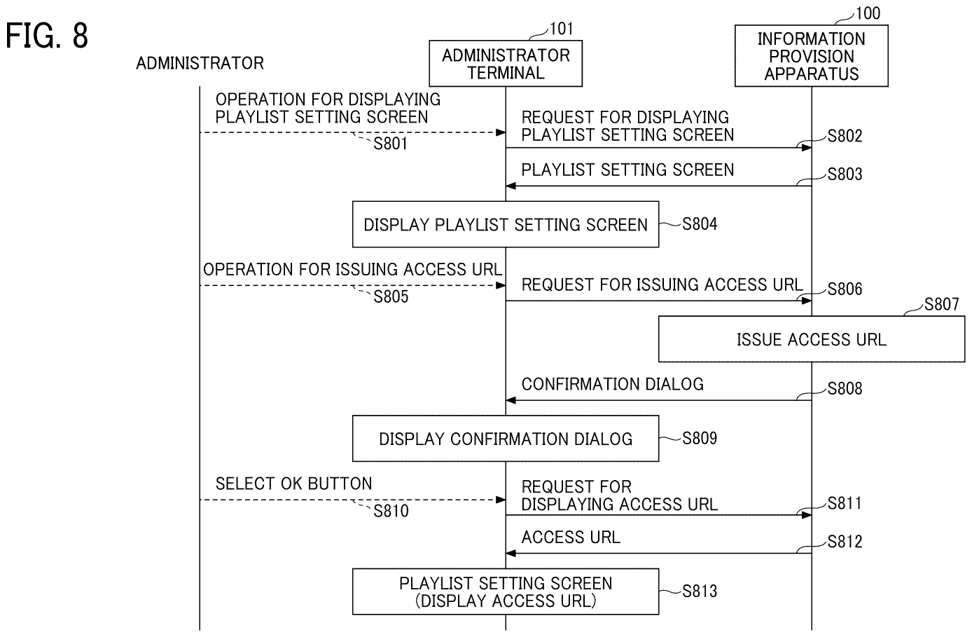

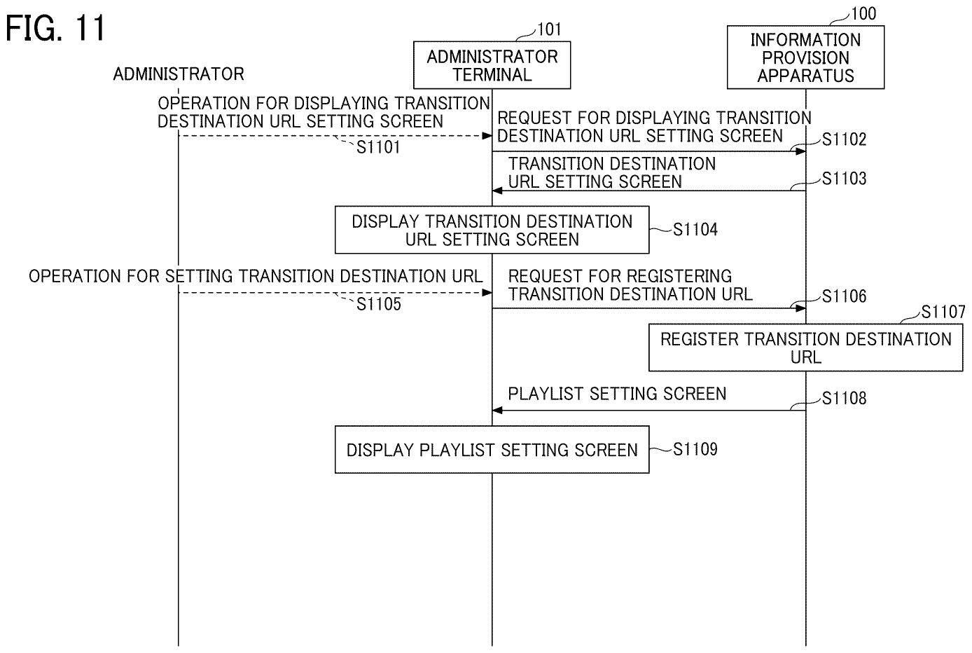

FIGS. 8 and 11 are sequence diagrams each illustrating an example setting process. This setting process is an example of a process in which the administrator managing the information provision system 1 sets the playlist information 412 illustrated in FIG. 5 for a created playlist. It is assumed that at the start of the setting process illustrated in FIG. 8, the administrator has created a playlist and the administrator terminal 101 is displaying the setting screen 600 as illustrated in FIG. 6.

In step S801, the administrator performs an operation for displaying a playlist setting screen on the administrator terminal 101. For example, the administrator may select a pre-set playlist 602 on the setting screen 600 to display the playlist setting screen 700.

In step S802, when the operation reception unit 423 of the administrator terminal 101 receives the operation for displaying the playlist setting screen 700, the operation reception unit 423 transmits a request for displaying the playlist setting screen 700 to the information provision apparatus 100.

In step S803, when the setting reception unit 402 of the information provision apparatus 100 receives the request for displaying the playlist setting screen 700, the setting reception unit 402 transmits, for example, the playlist setting screen 700 illustrated in FIG. 7 to the administrator terminal 101.

In step S804, the display control unit 422 of the administrator terminal 101 displays the playlist setting screen 700 received from the information provision apparatus 100 on the display device such as the display 206.

In step S805, the administrator performs, on the playlist setting screen 700, an operation for issuing an access URL (second link information) for displaying virtual signage (second content). For example, the administrator may perform the operation for issuing the access URL by selecting an “issue URL for virtual signage” button 704 on the playlist setting screen 700. The virtual signage is an example of the second content. An access URL is an example of the access information and the second link information.

In step S806, when the operation reception unit 423 of the administrator terminal 101 receives the operation for issuing the access URL, the operation reception unit 423 transmits a request for issuing the access URL to the information provision apparatus 100.

In step S807, the setting reception unit 402 of the information provision apparatus 100 issues the access URL. For example, the setting reception unit 402 issues, for the playlist to be set, a “URL for displaying a virtual reproduction list” and a “URL for not displaying a virtual reproduction list” described with reference to FIG. 5, and stores the issued URLs in the playlist information 412.

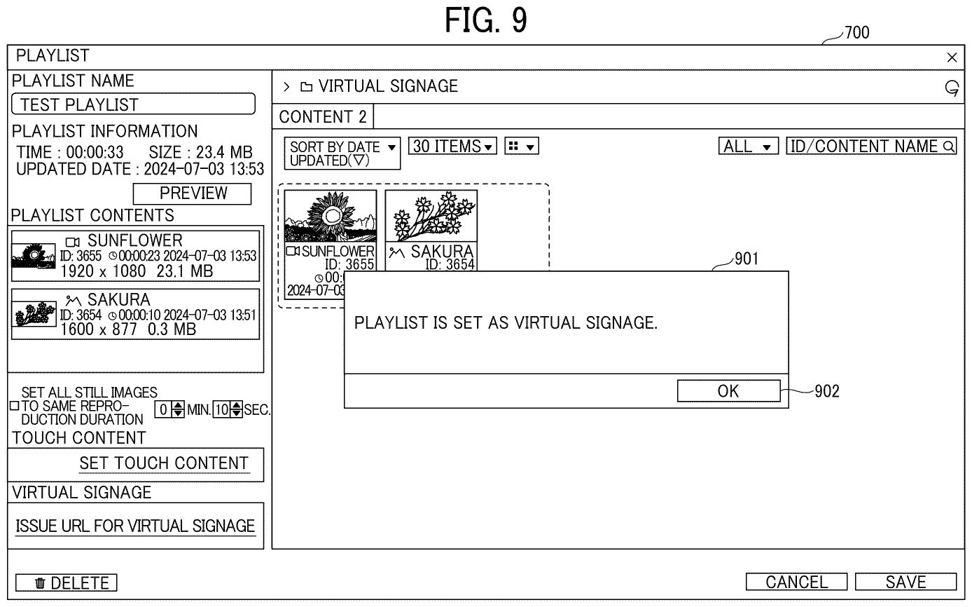

In step S808, the setting reception unit 402 transmits, for example, a confirmation dialog 901 as illustrated in FIG. 9 to the administrator terminal 101.

In step S809, the display control unit 422 of the administrator terminal 101 displays the confirmation dialog 901, which has been received from the information provision apparatus 100, on the playlist setting screen 700 as illustrated in FIG. 9, for example.

In step S810, the administrator selects an “OK” button 902 on the confirmation dialog 901.

In step S811, when the operation reception unit 423 of the administrator terminal 101 receives the operation of selecting the “OK” button 902, the operation reception unit 423 transmits an access URL display request to the information provision apparatus 100.

In step S812, when the setting reception unit 402 of the information provision apparatus 100 receives the access URL display request, the setting reception unit 402 transmits the issued access URL to the administrator terminal 101. For example, the setting reception unit 402 transmits the “URL for displaying a virtual reproduction list” and the “URL for not displaying a virtual reproduction list” issued in step S807 to the administrator terminal 101.

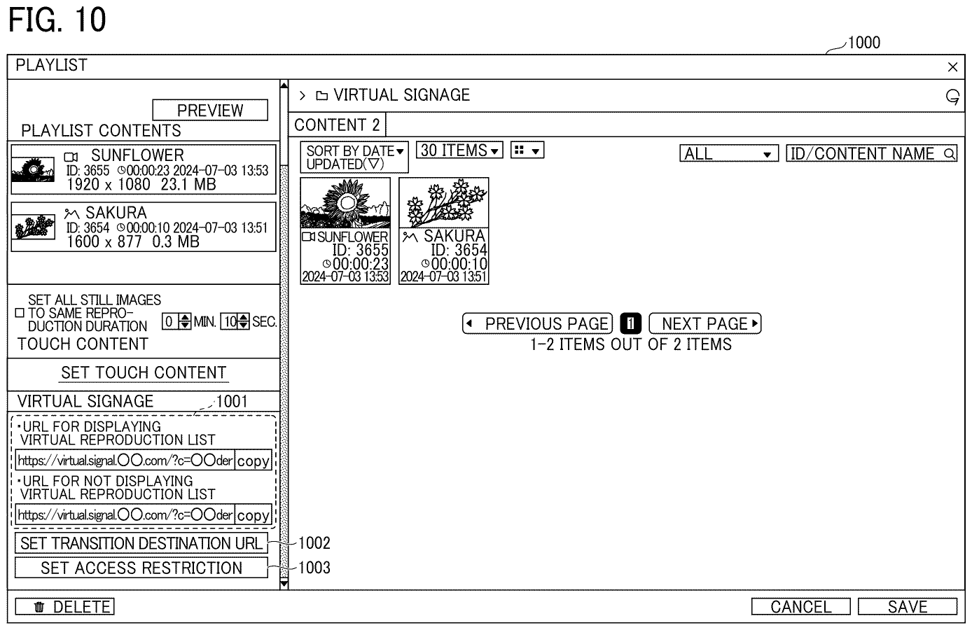

In step S813, when the display control unit 422 of the administrator terminal 101 receives the access URL from the information provision apparatus 100, the display control unit 422 displays, for example, a playlist setting screen 1000 as illustrated in FIG. 10. The playlist setting screen 1000 displays an access URL 1001. In the example illustrated in FIG. 10, the “URL for displaying a virtual reproduction list” and the “URL for not displaying a virtual reproduction list” received from the information provision apparatus 100 are displayed in the access URL 1001.

For example, the administrator copies the access URL 1001 and provides the access URL 1001 to the user. This allows the user to access a URL included in the provided access URL 1001 using the information terminal 102 to view virtual signage (second content), for example. In another example, the user may access a web page in which virtual signage is embedded using, for example, an inline frame (iframe) to view the virtual signage on the information terminals 102.

When the administrator sets a transition destination URL (first link information), the administrator further performs a process illustrated in FIG. 11.

In step S1101, the administrator performs an operation for displaying a transition destination URL setting screen, which is a setting screen for setting a transition destination URL. For example, the administrator may select a “set transition destination URL” button 1002 on the playlist setting screen 1000 as illustrated in FIG. 10 to display a transition destination URL setting screen 1200.

In step S1102, when the operation reception unit 423 of the administrator terminal 101 receives the operation for displaying the transition destination URL setting screen 1200, the operation reception unit 423 transmits a request for displaying the transition destination URL setting screen 1200 to the information provision apparatus 100.

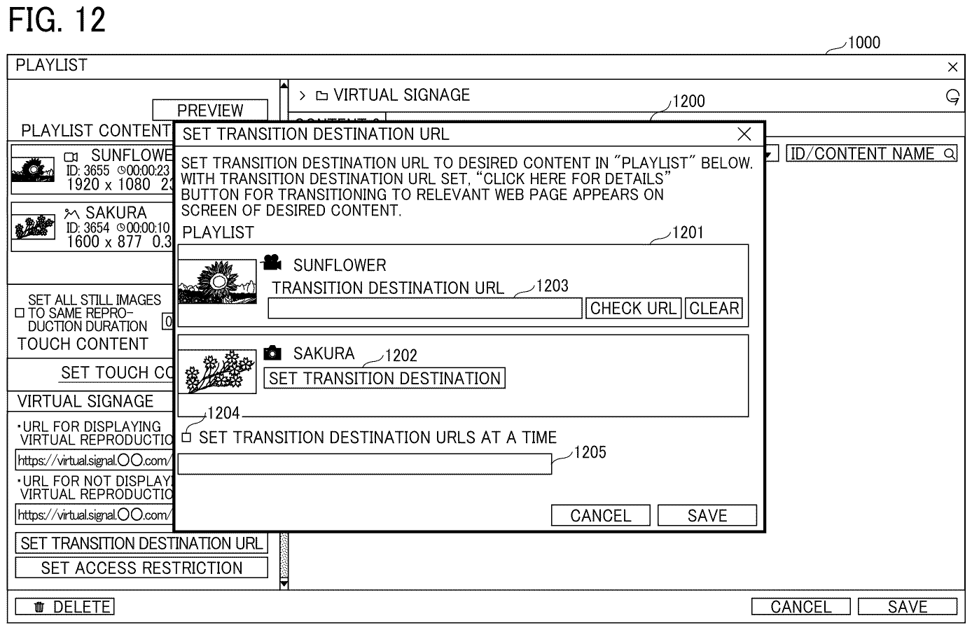

In step S1103, when the setting reception unit 402 of the information provision apparatus 100 receives the request for displaying the transition destination URL setting screen 1200, the setting reception unit 402 transmits the transition destination URL setting screen 1200 as illustrated in FIG. 12 to the administrator terminal 101.

In step S1104, the display control unit 422 of the administrator terminal 101 displays the transition destination URL setting screen 1200 received from the information provision apparatus 100 on a playlist setting screen 1000, as illustrated in FIG. 12, for example.

In step S1105, the administrator performs an operation for setting a transition destination URL. For example, the administrator may select a “set a transition destination” button 1202 for each content in a playlist 1201 on the transition destination URL setting screen 1200 as illustrated in FIG. 12 to display a transition destination URL input field 1203. The administrator may input a URL in the transition destination URL input field 1203 to set a transition destination URL for each content.

With the transition destination URL set, a “click here for details” button for transitioning to a relevant web page appears on a screen of the content for which the transition destination URL has been set. Selecting the “click here for details” button allows the user to access the URL set as the transition destination URL.

The administrator may check a “set transition destination URLs at a time” checkbox 1204 as illustrated in FIG. 12 and input a URL in an input field 1205 to set a transition destination URL for all the items of content at a time.

Referring back to FIG. 11, the description of the sequence diagram continues. In step S1106, when the operation reception unit 423 of the administrator terminal 101 receives the operation for setting the transition destination URL, the operation reception unit 423 transmits a request for registering the transition destination URL to the information provision apparatus 100.

In step S1107, when the setting reception unit 402 of the information provision apparatus 100 receives the request for registering the transition destination URL, the setting reception unit 402 registers the transition destination URL. For example, the setting reception unit 402 registers, in the playlist information 412 as illustrated in FIG. 5, the transition destination URL included in the request for registering the transition destination URL in the item “transition destination URL for virtual signage” of the playlist to be set.

In step S1108, the setting reception unit 402 of the information provision apparatus 100 transmits, for example, the playlist setting screen 1000 as illustrated in FIG. 10 to the administrator terminal 101.

In step S1109, the display control unit 422 of the administrator terminal 101 displays the playlist setting screen 1000 received from the information provision apparatus 100.

The processes illustrated in FIGS. 8 and 11 allow the administrator to set, for example, the playlist information 412 as illustrated in FIG. 5.

### Provision Process

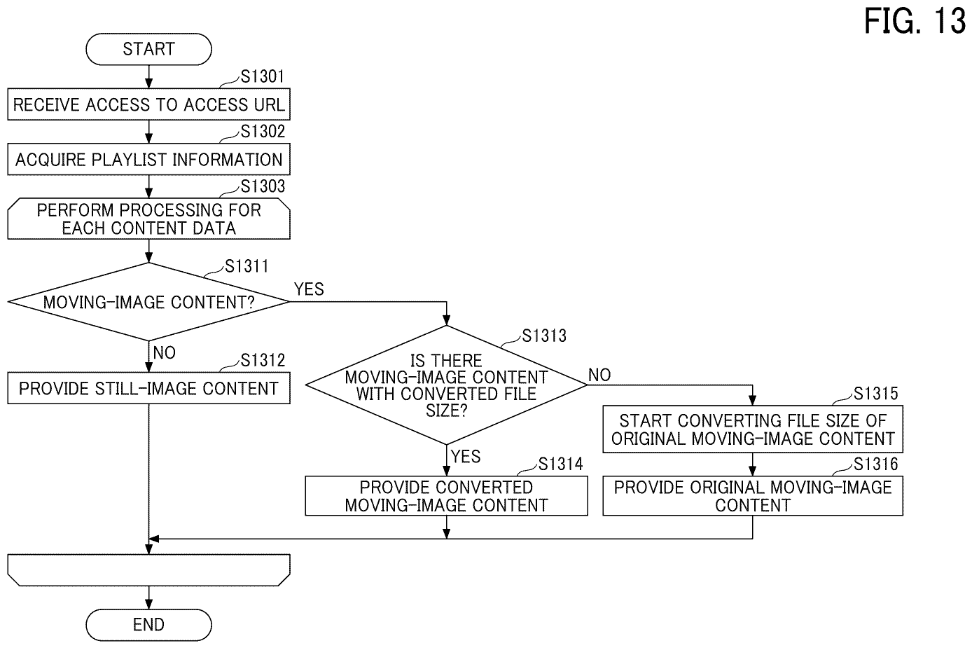

FIG. 13 is a flowchart illustrating an example provision process according to the first embodiment. This provision process is an example of a process in which the provision unit 405 of the information provision apparatus 100 provides the second content to the information terminal 102 used by the user. It is assumed that at the start of the provision process illustrated in FIG. 13, the playlist information 412 as illustrated in FIG. 5 has been set.

In step S1301, when the information provision apparatus 100 receives access to the access URL, the information provision apparatus 100 performs processing in step S1302 and subsequent steps. The access URL corresponds to, for example, the “URL for displaying a virtual reproduction list” or the “URL for not displaying a virtual reproduction list” in the playlist information 412 illustrated in FIG. 5.

In step S1302, the content creation unit 404 acquires playlist information. For example, the content creation unit 404 acquires playlist information (e.g., information regarding a playlist A) corresponding to the access URL from the playlist information 412 as illustrated in FIG. 5.

In step S1303, the information provision apparatus 100 performs processing in steps S1311 to S1316 for each content data included in the playlist.

In step S1311, the provision unit 405 determines whether or not the content data is moving-image content. In a case where the content data is not moving-image content (i.e., the content data is still-image content), the provision unit 405 causes the process to proceed to step S1312. In a case where the content data is moving-image content, the provision unit 405 causes the process to proceed to step S1313.

When the process proceeds to step S1312, the provision unit 405 provides still-image content to the information terminal 102 that has accessed the access URL. For example, in a case where a transition destination URL is set for the still-image content, the content creation unit 404 creates, based on original still-image content, still-image content for provision on which a display element for displaying a reference destination indicated by the transition destination URL (first link information) is displayed. As a specific example, the content creation unit 404 creates still-image content for provision on which a “click here for details” button is displayed. The “click here for details” button is an example of the display element for displaying the reference destination indicated by the first link information.

In a case where no transition destination URL is set for the still-image content, the content creation unit 404 creates, based on the original still-image content, still-image content for provision on which a display element for displaying a reference destination indicated by a transition destination URL (first link information) is not displayed.

The provision unit 405 provides the still-image content for provision created by the content creation unit 404 to the information terminal 102 that has accessed the access URL.

When the process proceeds from step S1311 to step S1313, the provision unit 405 determines whether or not there is moving-image content with a file size converted, specifically, reduced, from the file size of the moving-image content. In a case where there is moving-image content with the converted file size, the provision unit 405 causes the process to proceed to step S1314. In a case where there is no moving-image content with the converted file size, the provision unit 405 causes the process to proceed to step S1315.

When the process proceeds to step S1314, the provision unit 405 provides the converted moving-image content to the information terminal 102 that has accessed the access URL. For example, in a case where a transition destination URL is set for the moving-image content, the content creation unit 404 creates, based on the converted moving-image content, moving-image content for provision on which a display element for displaying a reference destination indicated by the transition destination URL (first link information) is displayed. As a specific example, the content creation unit 404 creates moving-image content for provision on which a “click here for details” button is displayed. In a case where no transition destination URL is set for the moving-image content, the content creation unit 404 sets the converted moving-image content as the moving-image content for provision.

The provision unit 405 provides the moving-image content for provision created by the content creation unit 404 to the information terminal 102 that has accessed the access URL.

When the process proceeds from step S1313 to S1315, the content creation unit 404 starts converting the original moving-image content into moving-image content with a smaller file size. For example, the content creation unit 404 may reduce the resolution of an image of the original moving-image content or compress the image of the original moving-image content to create converted moving-image content with a smaller file size than the original moving-image content.

In step S1316, the provision unit 405 provides the original moving-image content to the information terminal 102 that has accessed the access URL. For example, in a case where a transition destination URL is set for the moving-image content, the content creation unit 404 creates, based on the original moving-image content, moving-image content for provision on which a display element for displaying a reference destination indicated by the transition destination URL (first link information) is displayed. As a specific example, the content creation unit 404 creates moving-image content for provision on which a “click here for details” button is displayed. In a case where no transition destination URL is set for the moving-image content, the content creation unit 404 sets the original moving-image content as the moving-image content for provision.

The provision unit 405 provides the moving-image content for provision created by the content creation unit 404 to the information terminal 102 that has accessed the access URL. In this way, the provision unit 405 provides the moving-image content for provision to the information terminal 102 without waiting for the content creation unit 404 to finish converting the file size of the moving-image content.

The provision process illustrated in FIG. 13 is merely an example. For example, in a case where the content data is still-image content, the information provision apparatus 100 may provide converted still-image content as still-image content for provision. In this case, as with moving-image content, the information provision apparatus 100 may convert original still-image content into a smaller size to obtain converted still-image content.

Further, the content creation unit 404 of the information provision apparatus 100 may create converted moving-image content with a reduced file size from original moving-image content when the setting reception unit 402 receives a request for issuing an access URL from the administrator terminal 101 in step 806 of FIG. 8. Similarly, the content creation unit 404 may create converted still-image content with a reduced file size from original still-image content when the setting reception unit 402 receives a request for issuing an access URL from the administrator terminal 101.

In this way, the content creation unit 404 of the information provision apparatus 100 may create converted content data (moving-image content or still-image content) after the setting reception unit 402 receives a request for issuing an access URL from the administrator terminal 101. This configuration prevents the conversion of content data that is not to be provided to the information terminal 102.

The configuration of the information provision apparatus 100 is not limited thereto. For example, when content data (moving-image content or still-image content) is registered in the information provision apparatus 100, the content creation unit 404 of the information provision apparatus 100 may create converted content data. This reduces the load of the information provision apparatus 100 when content (second content) for provision is provided.

### Example Display Screen

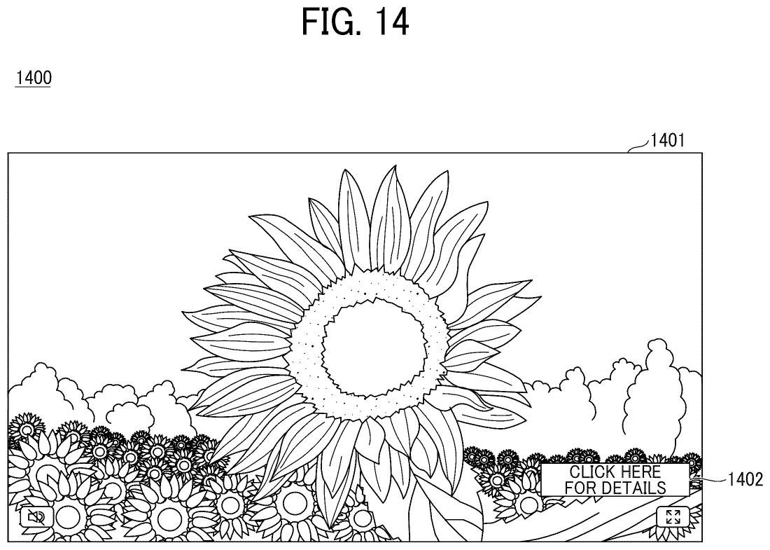

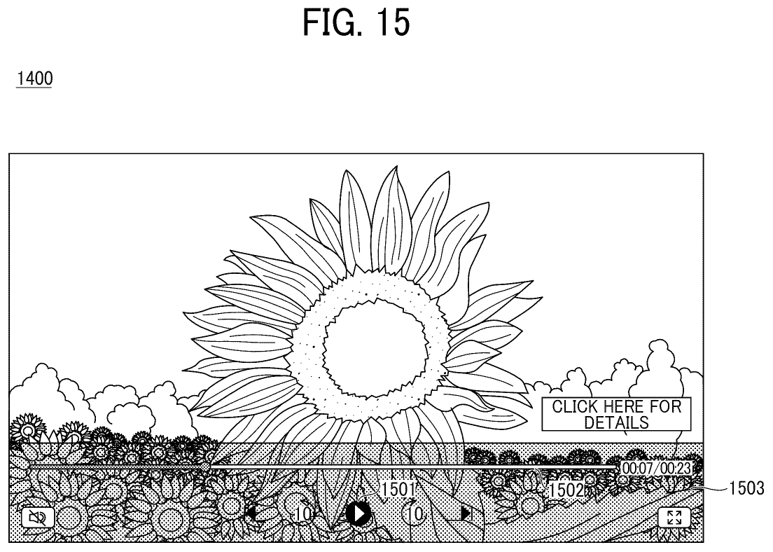

FIGS. 14 and 15 are views of example display screens without a reproduction list. When the user specifies an access URL for not displaying a reproduction list, the provision unit 405 of the information provision apparatus 100 provides, for example, second content 1401 illustrated in FIG. 14 to the information terminal 102. In response, the second content 1401 is displayed on a display screen 1400 of the information terminal 102.

In the example illustrated in FIG. 14, the second content 1401 displays a “click here for details” button 1402. In this case, for example, the user may select the “click here for details” button 1402 to display a web page indicated by a transition destination URL (first link information) on a separate tab. In a case where no transition destination URL is set, the “click here for details” button 1402 is not displayed on the second content 1401.

The user may perform a predetermined operation (e.g., hover a mouse over the bottom of the screen) on the display screen 1400 to display an operation area 1503, which includes, for example, an operation button 1501 and a seek bar 1502, as illustrated in FIG. 15.

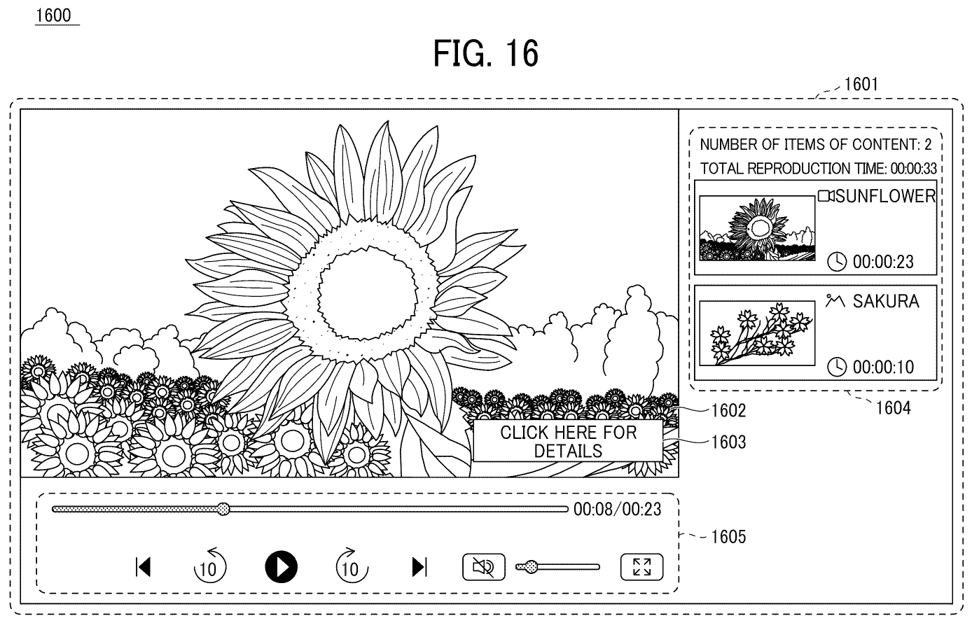

FIG. 16 is a view of an example display screen with a reproduction list. When the user specifies an access URL for displaying a reproduction list, the provision unit 405 of the information provision apparatus 100 provides, for example, second content 1601 illustrated in FIG. 16 to the information terminal 102. In response, the second content 1601 is displayed on a display screen 1600 of the information terminal 102.

In the example illustrated in FIG. 16, the second content displays a content image 1602, a “click here for details” button 1603, a reproduction list 1604, and an operation area 1605. The reproduction list 1604 displays a list of items of content (at least one of moving-image content and still-image content) to be reproduced. In a case where no transition destination URL is set, the “click here for details” button 1603 is not displayed on the second content 1601.

Preferably, the user may select desired content from the reproduction list 1604 to reproduce the content.

In this way, according to the first embodiment, content is displayed on the information terminal 102 used by the user in addition to the display apparatus 111 disposed in a predetermined location.

### SECOND EMBODIMENT

In a second embodiment, an example access restriction for restricting access to the second content (virtual content) is described. The first content is distributed to the authenticated display control apparatus 110 or the authenticated display apparatus 111. Therefore, access restriction is not set for the first content. However, the second content is accessible by anyone who knows the URL of the second content. Therefore, it is preferable that access restriction be set for the second content when security is a concern.

### Access Restriction Setting Process

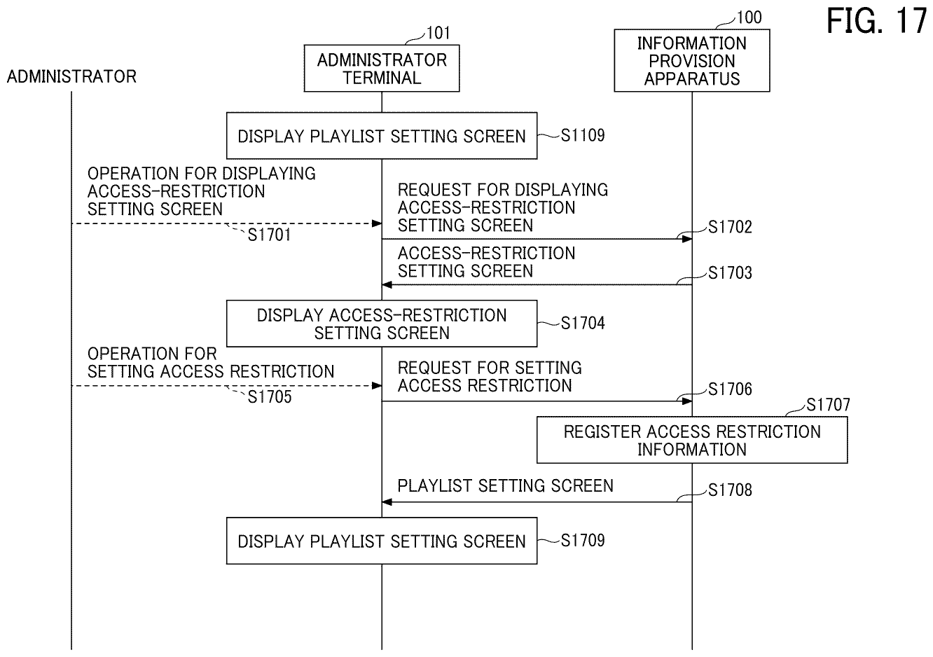

FIG. 17 is a sequence diagram illustrating an example access restriction setting process according to the second embodiment. It is assumed that at the start of the setting process illustrated in FIG. 17, specifically, in step S1109 of FIG. 17, the administrator terminal 101 is displaying the playlist setting screen 1000 as illustrated in FIG. 10.

In step S1701, the administrator performs an operation for displaying an access-restriction setting screen, which is a setting screen for setting access restriction. For example, the administrator may select a “set access restriction” button 1003 on the playlist setting screen 1000 as illustrated in FIG. 10 to display an access-restriction setting screen 1800.

In step S1702, when the operation reception unit 423 of the administrator terminal 101 receives the operation for displaying the access-restriction setting screen 1800, the operation reception unit 423 transmits a request for displaying the access-restriction setting screen 1800 to the information provision apparatus 100.

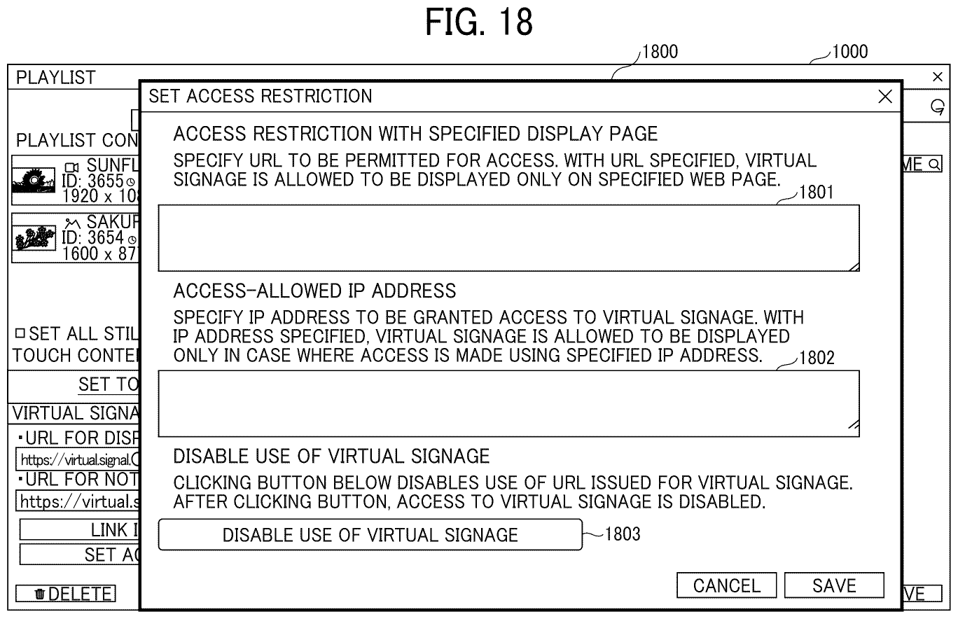

In step S1703, when the setting reception unit 402 of the information provision apparatus 100 receives the request for displaying the access-restriction setting screen 1800, the setting reception unit 402 transmits, for example, the access-restriction setting screen 1800 illustrated in FIG. 18 to the information terminal 102.

In step S1704, the display control unit 422 of the administrator terminal 101 displays the access-restriction setting screen 1800 received from the information provision apparatus 100, for example, as illustrated in FIG. 18.

In step S1705, the administrator performs an operation for setting access restriction on the access-restriction setting screen 1800 illustrated in FIG. 18. For example, the administrator inputs an access-allowed URL to an “access restriction with a specified display page” setting field 1801 and an access-allowed IP address to an “access-allowed IP address” setting field 1802. The administrator may input one of the access-allowed URL and the access-allowed IP address in the corresponding field. The administrator selects a “disable the use of virtual signage” button 1803 to disable the use of virtual signage.

When the operation reception unit 423 of the administrator terminal 101 receives the operation for setting access restriction in step S1705, the operation reception unit 423 transmits a request for setting the access restriction to the information provision apparatus 100 in step S1706.

In step S1707, the setting reception unit 402 of the information provision apparatus 100 registers the information input or selected by the administrator in step S1705. For example, the setting reception unit 402 registers the access-allowed URL in the item “access restriction with a specified display page” of the playlist information 412 illustrated in FIG. 5 for the playlist to be set. The setting reception unit 402 also registers the access-allowed IP address in the item “access-allowed IP address” of the playlist information 412 illustrated in FIG. 5 for the playlist to be set. When the “disable the use of virtual signage” button 1803 is selected, the setting reception unit 402 sets the “virtual signage setting” of the playlist information 412 to OFF.

In step S1708, the setting reception unit 402 of the information provision apparatus 100 transmits, for example, the playlist setting screen 1000 as illustrated in FIG. 10 to the administrator terminal 101.

In step S1709, the display control unit 422 of the administrator terminal 101 displays the playlist setting screen 1000 received from the information provision apparatus 100.

FIG. 18 is a view of the example access-restriction setting screen according to the second embodiment. In the example illustrated in FIG. 18, the access-restriction setting screen 1800 displays the “access restriction with a specified display page” setting field 1801, the “access-allowed IP address” setting field 1802, and the “disable the use of virtual signage” button 1803.

The “access restriction with a specified display page” setting field 1801 is a setting field for setting a restriction such that the second content (virtual signage) is allowed to be displayed only on a specified web page. When the administrator specifies an access-allowed URL in the “access restriction with a specified display page” setting field 1801, the specified URL is registered in the item “access restriction with a specified display page” of the playlist information 412 as illustrated in FIG. 5, for example.

In this case, the provision unit 405 of the information provision apparatus 100 sets a restriction such that the second content (virtual signage) is allowed to be displayed only on a web page with the specified URL.

The “access-allowed IP address” setting field 1802 is a setting field for setting a restriction such that the second content (virtual signage) is allowed to be displayed only in a case where the access is made using the specified IP address. When the administrator specifies the IP address that is to be granted access to the second content in the “access-allowed IP address” setting field 1802, the specified IP address is registered in the item “access-allowed IP address” of the playlist information 412 as illustrated in FIG. 5, for example. The specified IP address may be, for example, a range of IP addresses or an IP address with a wildcard indicating a desired character string.

In this case, the provision unit 405 of the information provision apparatus 100 sets a restriction such that the second content (virtual signage) is allowed to be displayed only in a case where the access is made using the specified IP address.

The “disable the use of virtual signage” button 1803 is a setting button for setting a restriction such that the display of the second content (virtual signage) is disallowed. When the administrator selects the “disable the use of virtual signage” button 1803, the “virtual signage setting” of the playlist information 412 as illustrated in FIG. 5 is set to OFF. In this case, the provision unit 405 of the information provision apparatus 100 does not provide the second content to the information terminal 102.

In this way, the information provision apparatus 100 according to the second embodiment sets access restriction to the second content. The second embodiment may be applied in combination with the first embodiment.

### THIRD EMBODIMENT

In a third embodiment, an example of a process performed in accordance with the data transfer volume of each of the first content and the second content provided by the information provision apparatus 100 is described.

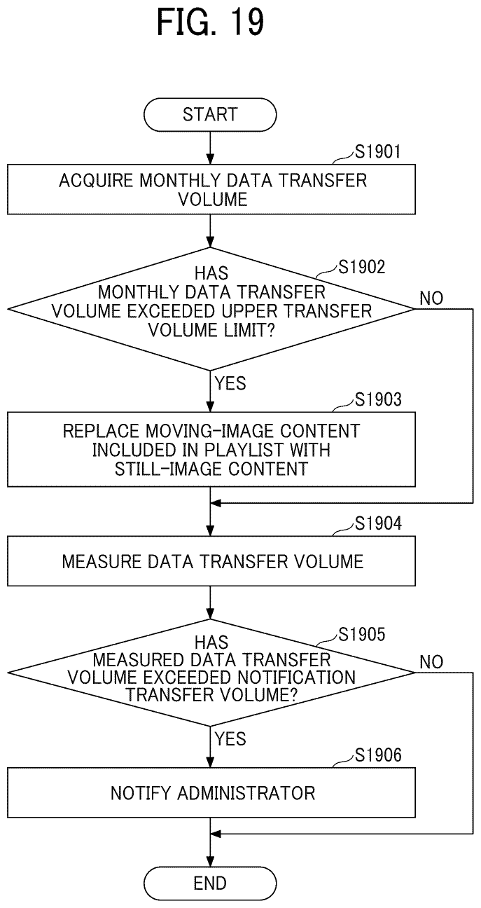

FIG. 19 is a flowchart illustrating an example process performed in accordance with the data transfer volume according to the third embodiment. The management unit 406 of the information provision apparatus 100 manages the data transfer volume of the first content distributed by the distribution unit 403 for a predetermined client and the data transfer volume of the second content provided by the provision unit 405 for the predetermined client. The predetermined client is assumed to use at least one of two or more display control apparatuses 110 and two or more display apparatuses 111, and two or more information terminals 102.

In step S1901, the management unit 406 acquires a monthly data transfer volume of each of the first content and the second content for the predetermined client.

In step S1902, the management unit 406 determines whether or not the acquired monthly data transfer volume has exceeded an upper transfer volume limit (first threshold value). The upper transfer volume limit refers to, for example, a maximum monthly data transfer volume predetermined in a contract with the predetermined client. The upper transfer volume limit is an example of the first threshold value. For example, the first threshold value may be any other value, such as 90% of the upper transfer volume limit.

In a case where the monthly data transfer volume has exceeded the upper transfer volume limit, the management unit 406 causes the process to proceed to step S1903. In a case where the monthly data transfer volume has not exceeded the upper transfer volume limit, the management unit 406 causes the process to proceed to step S1904.

When the process proceeds to step S1903, the management unit 406 replaces moving-image content included in a playlist with still-image content. For example, in a case where a playlist includes moving-image content, the management unit 406 replaces the moving-image content with a still image for thumbnail display. In this way, in a case where the monthly data transfer volume has exceeded the upper transfer volume limit, the management unit 406 reduces the data size of the second content provided by the provision unit 405.

In step S1904, the management unit 406 measures the data transfer volume of at least one of the first content and the second content. The data transfer volume may be, for example, measured in real time or on a daily basis. The data transfer volume may be measured by any other method.

In step S1905, the management unit 406 determines whether or not the measured data transfer volume has exceeded a pre-set notification transfer volume (second threshold value). The notification transfer volume is a pre-set value for determining whether to notify the administrator. The notification transfer volume is an example of the second threshold value.

In a case where the measured data transfer volume has exceeded the notification transfer volume, the management unit 406 causes the process to proceed to step S1906. In a case where the measured data transfer volume has not exceeded the notification transfer volume, the management unit 406 ends the process illustrated in FIG. 19.

When the process proceeds to step S1906, the notification unit 407 of the information provision apparatus 100 transmits a predetermined notification to the administrator. For example, the notification unit 407 transmits an email to the administrator's email address to notify the administrator that the data transfer volume has exceeded the notification transfer volume. This allows the administrator to be aware that the data transfer volume is increasing or the data transfer volume is approaching the upper transfer volume limit, thereby allowing the administrator to adjust, for example, the resolution or the display time of moving-image content as necessary.

According to one or more embodiments of the present disclosure, content is displayed on the information terminal used by the user, in addition to the display apparatus disposed in a predetermined location.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The illustrated apparatuses are only illustrative of one of several computing environments for implementing the embodiments disclosed herein. For example, in some embodiments, the information provision apparatus 100 includes a plurality of computing devices, e.g., a server cluster, that are configured to communicate with each other over any type of communications link, including a network, a shared memory, etc. to collectively perform the processes disclosed herein. Further, the illustrated elements of the information provision apparatus 100 can be combined into a single server apparatus, or divided between a plurality of machines in combinations.

### ASPECTS

An information provision apparatus, an information provision system, an information provision method, and a program according to the following aspects are disclosed herein.

### Aspect 1

According to Aspect 1, an information provision apparatus provides second content, which is created from first content to be displayed on a display apparatus and which is to be displayed on an information terminal used by a user. The information provision apparatus includes a playlist creation unit, a setting reception unit, a distribution unit, and a provision unit. The playlist creation unit creates a playlist including the first content. In response to receiving a request for issuing access information for providing the first content included in the playlist to the information terminal, the setting reception unit issues the access information. The distribution unit distributes the first content included in the playlist to the display apparatus or a display control apparatus that causes the display apparatus to display the first content. In response to receiving access to the access information from the information terminal, the provision unit provides the information terminal with the second content that is created from the first content included in the playlist and that is optimized for the information terminal.

### Aspect 2

According to Aspect 2, the information provision apparatus of Aspect 1 further includes a communication unit to communicate with an administrator terminal that displays a setting screen for receiving an input of first link information for displaying information relating to the first content. The setting reception unit receives information set on the setting screen. The second content displays a display element for displaying a reference destination indicated by the first link information.

### Aspect 3

According to Aspect 3, the information provision apparatus of Aspect 1 or 2 further includes a content creation unit to create the second content optimized for the information terminal.

### Aspect 4

According to Aspect 4, in the information provision apparatus of Aspect 3, the content creation unit reduces resolution of content data included in the first content or compresses the content data included in the first content to create the second content optimized for the information terminal.

### Aspect 5

According to Aspect 5, in the information provision apparatus of Aspect 3, the content creation unit increases resolution of content data included in the first content to create the second content optimized for the information terminal.

### Aspect 6

According to Aspect 6, in the information provision apparatus of Aspect 3, the content creation unit creates the second content optimized for the information terminal after the setting reception unit receives the request for issuing the access information.

### Aspect 7

According to Aspect 7, in the information provision apparatus of Aspect 3, the setting reception unit receives a setting for content data included in the first content. In response to receiving the setting for the content data included in the first content, the content creation unit creates the second content optimized for the information terminal.

### Aspect 8

According to Aspect 8, in the information provision apparatus of Aspect 3, in a case where the provision unit provides the second content, the content creation unit optimizes unoptimized moving-image content included in the second content.

### Aspect 9

According to Aspect 9, the information provision apparatus of any one of Aspects 1 to 8 further includes a management unit to manage a data transfer volume of the second content. In a case where the data transfer volume during a predetermined period has exceeded a first threshold value, the management unit reduces a data size of the second content.

### Aspect 10

According to Aspect 10, in the information provision apparatus of Aspect 9, the management unit replaces moving-image content included in the second content with still-image content to reduce the data size of the second content.

### Aspect 11

According to Aspect 11, the information provision apparatus of any one of Aspects 1 to 8 further includes a management unit and a notification unit. The management unit manages a data transfer volume of the second content. In a case where the data transfer volume has exceeded a second threshold value, the notification unit notifies a predetermined notification destination that the data transfer volume has exceeded the second threshold value.

### Aspect 12

According to Aspect 12, in the information provision apparatus of any one of Aspects 1 to 11, the setting reception unit receives a setting of an access restriction to the second content.

### Aspect 13

According to Aspect 13, in the information provision apparatus of Aspect 12, the access restriction includes a restriction that allows display of the second content only in a case where the access is made using a specified IP address.

### Aspect 14

According to Aspect 14, in the information provision apparatus of Aspect 12, the access restriction includes a restriction that allows the second content to be displayed only on a specified web page.

### Aspect 15

According to Aspect 15, in the information provision apparatus of Aspect 12, the access restriction includes a restriction that disallows display of the second content.

### Aspect 16

According to Aspect 16, in the information provision apparatus of any one of Aspects 1 to 15, the access information includes an access uniform resource locator (URL) for accessing the second content.

### Aspect 17

According to Aspect 17, an information provision system includes an information provision apparatus and an administrator terminal that is communicable with the information provision apparatus. The information provision apparatus provides second content, which is created from first content to be displayed on a display apparatus and which is to be displayed on an information terminal used by a user. The information provision apparatus includes a playlist creation unit, a setting reception unit, a distribution unit, and a provision unit. The playlist creation unit creates a playlist including the first content. In response to receiving a request for issuing access information for providing the first content included in the playlist to the information terminal, the setting reception unit issues the access information. The distribution unit distributes the first content included in the playlist to the display apparatus or a display control apparatus that causes the display apparatus to display the first content. In response to receiving access to the access information from the information terminal, the provision unit provides the information terminal with the second content that is created from the first content included in the playlist and that is optimized for the information terminal. The administrator terminal includes a display control unit and an operation reception unit. The display control unit displays a setting screen for receiving an input of first link information for displaying information relating to the first content. In response to receiving the input of the first link information, the operation reception unit transmits the first link information to the information provision apparatus.

### Aspect 18

According to Aspect 18, an information provision method is performed by a computer that provides second content, which is created from first content to be displayed on a display apparatus and which is to be displayed on an information terminal used by a user. The information provision method includes creating a playlist including the first content, in response to receiving a request for issuing access information for providing the first content included in the playlist to the information terminal, issuing the access information, distributing the first content included in the playlist to the display apparatus or a display control apparatus that causes the display apparatus to display the first content, and in response to receiving access to the access information from the information terminal, providing the information terminal with the second content that is created from the first content included in the playlist and that is optimized for the information terminal.

### Aspect 19

According to Aspect 19, a program causes a computer to perform a method. The computer provides second content, which is created from first content to be displayed on a display apparatus and which is to be displayed on an information terminal used by a user. The method performed by the computer includes creating a playlist including the first content, in response to receiving a request for issuing access information for providing the first content included in the playlist to the information terminal, issuing the access information, distributing the first content included in the playlist to the display apparatus or a display control apparatus that causes the display apparatus to display the first content, and in response to receiving access to the access information from the information terminal, providing the information terminal with the second content that is created from the first content included in the playlist and that is optimized for the information terminal.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information provision apparatus comprising circuitry configured to:
create a playlist including first content to be displayed on a display apparatus;
in response to receiving a request for issuing access information for providing the first content to an information terminal used by a user, issue the access information;
distribute the first content included in the playlist; and
in response to receiving access from the information terminal using the access information, provide the information terminal with second content optimized for the information terminal, the second content being created from the first content and to be displayed on the information terminal.

2. The information provision apparatus according to claim 1,
wherein the circuitry is configured to:
communicate with an administrator terminal that displays a setting screen for receiving an input of first link information for displaying information relating to the first content; and
receive information set on the setting screen, and
the second content displays a display element for displaying a reference destination indicated by the first link information.

3. The information provision apparatus according to claim 1, wherein the circuitry is configured to create the second content optimized for the information terminal.

4. The information provision apparatus according to claim 3, wherein the circuitry is configured to reduce resolution of content data included in the first content to create the second content optimized for the information terminal.

5. The information provision apparatus according to claim 3, wherein the circuitry is configured to compress content data included in the first content to create the second content optimized for the information terminal.

6. The information provision apparatus according to claim 3, wherein the circuitry is configured to increase resolution of content data included in the first content to create the second content optimized for the information terminal.

7. The information provision apparatus according to claim 3, wherein the circuitry is configured to create the second content optimized for the information terminal after the circuitry receives the request for issuing the access information.

8. The information provision apparatus according to claim 3, wherein the circuitry is configured to create the second content optimized for the information terminal in response to receiving a setting for content data included in the first content.

9. The information provision apparatus according to claim 3, wherein, in a case where the circuitry provides the second content, the circuitry is configured to optimize unoptimized moving-image content included in the second content.

10. The information provision apparatus according to claim 1, wherein the circuitry is configured to:
manage a data transfer volume of the second content; and
in a case where the data transfer volume during a predetermined period has exceeded a first threshold value, reduce a data size of the second content.

11. The information provision apparatus according to claim 10, wherein the circuitry is configured to replace moving-image content included in the second content with still-image content to reduce the data size of the second content.

12. The information provision apparatus according to claim 1, wherein the circuitry is configured to:
manage a data transfer volume of the second content; and
in a case where the data transfer volume has exceeded a second threshold value, notify a predetermined notification destination that the data transfer volume has exceeded the second threshold value.

13. The information provision apparatus according to claim 1, wherein the circuitry is configured to receive a setting of an access restriction to the second content.

14. The information provision apparatus according to claim 13, wherein the access restriction includes a restriction that allows display of the second content only in a case where the access is made using a specified IP address.

15. The information provision apparatus according to claim 13, wherein the access restriction includes a restriction that allows the second content to be displayed only on a specified web page.

16. The information provision apparatus according to claim 13, wherein the access restriction includes a restriction that disallows display of the second content.

17. The information provision apparatus according to claim 1, wherein the access information includes an access uniform resource locator (URL) for accessing the second content.

18. An information provision system comprising:
an information provision apparatus including first circuitry; and
an administrator terminal including second circuitry and being communicable with the information provision apparatus,
the first circuitry being configured to:
create a playlist including first content to be displayed on a display apparatus;
in response to receiving a request for issuing access information for providing the first content to an information terminal used by a user, issue the access information;
distribute the first content included in the playlist; and
in response to receiving access from the information terminal using the access information, provide the information terminal with second content optimized for the information terminal, the second content being created from the first content and to be displayed on the information terminal,
the second circuitry being configured to:
display a setting screen for receiving an input of first link information for displaying information relating to the first content; and
in response to receiving the input of the first link information, transmit the first link information to the information provision apparatus.

19. An information provision method comprising:
creating a playlist including first content to be displayed on a display apparatus;
in response to receiving a request for issuing access information for providing the first content to an information terminal used by a user, issuing the access information;
distributing the first content included in the playlist; and
in response to receiving access from the information terminal using the access information, providing the information terminal with second content optimized for the information terminal, the second content being created from the first content and to be displayed on the information terminal.
